(19) United States
(12) Patent Application Publication
(10) Pub. No.: US 2022/0358441 A1
(43) Pub. Date: Nov. 10, 2022

(54) MONITORING AND MAINTENANCE APPARATUS, MONITORING AND MAINTENANCE METHOD, AND MONITORING AND MAINTENANCE PROGRAM

(71) Applicant: Nippon Telegraph and Telephone Corporation, Tokyo (JP)

(72) Inventors: Atsushi Takada, Musashino-shi, Tokyo (JP); Naoyuki TANJI, Musashino-shi, Tokyo (JP); Toshihiko Seki, Musashino-shi, Tokyo (JP); Kyoko YAMAGOE, Musashino-shi, Tokyo (JP)

(21) Appl. No.: 17/619,661

(22) PCT Filed: Jun. 20, 2019
(86) PCT No.: PCT/JP2019/024465

§ 371 Date: Dec. 16, 2021

(51) Int. Cl. G06Q 10/06

(52) U.S. Cl. CPC G06Q 10/06395; G06Q 10/06398

(57) ABSTRACT

In a monitoring and maintenance apparatus 1 that monitors a service for which service quality provisions have been established and sorts fault handling into automatic handling done automatically without the need for an operator, scheduled maintenance carried out by an operator in a predetermined time slot, and emergency measures taken promptly by an expert, an inquiry unit 121 extracts fault handling procedures and acquires a degree of impact of carrying out the handling procedures; a cost assessment unit 122 assesses cost according to a timing of carrying out the handling procedures and determines a timing that minimizes the cost; and a selection unit 13 selects a handling procedure to be carried out, based on cost required for handling and on the degree of impact, determines a timing that minimizes the cost as a start timing of the scheduled maintenance when the selected handling procedure is the scheduled maintenance, and sorts the selected handling procedure to any of the automatic handling, the scheduled maintenance, and the emergency measures.

### TECHNICAL FIELD

The present invention relates to a monitoring and maintenance apparatus, a monitoring and maintenance method, and a monitoring and maintenance program.

### BACKGROUND ART

In recent years, with the advancement of information and telecommunications technologies, a wide variety of communications services have been provided. In network operations of common carriers, SLA-driven operation is proposed, which automates maintenance-related determinations based on SLA (Service Level Agreement) reached with a user.

With the SLA-driven operation, operation-related determinations are made based on SLA using a service level indicator (SLI) and a service level target (SLT).

### CITATION LIST

### Non-Patent Literature

Non-Patent Literature 1: Yamakoshi et al., “SLA Driven Operation,” IEICE Technical Report, vol. 118, no.303, ICM2018-33, pp. 51-56, November 2018

### SUMMARY OF THE INVENTION

### Technical Problem

According to Non-Patent Literature 1, SLA-based determinations sort failure handling into automatic handling, scheduled maintenance, and experts. For example, according to cited literature 1, when there are standardized recovery procedures and scripts and tools are provided for automation, failure handling is sorted to automatic handling; when human intervention is necessary and there is SLA-stipulated margin in a deadline for handling, failure handling is sorted to scheduled maintenance carried out by operators in a predetermined time slot; and in the case of a failure for which there are no standardized recovery procedures or there is no SLA-stipulated margin in a deadline for handling, failure handling is sorted to experts.

However, cited reference 1 does not propose a method for determining a timing to do handling. In order to fully automate operation, it is necessary to determine an efficient timing to do handling.

The present invention has been made in view of the above circumstances and has an object to automatically and quickly determine an efficient timing to do handling.

### Means for Solving the Problem

According to one aspect of the present invention, there is provided a monitoring and maintenance apparatus that monitors a service for which service quality provisions have been established and sorts fault handling into automatic handling done automatically, scheduled maintenance carried out by an operator in a predetermined time slot, and emergency measures taken promptly by an expert, the apparatus comprising: an extraction unit adapted to extract fault handling procedures and acquire a degree of impact of carrying out the handling procedures; a cost assessment unit adapted to assess cost according to a timing of carrying out the handling procedures and determine a timing that minimizes the cost; and a selection unit adapted to select a handling procedure to be carried out, based on cost required for handling and on the degree of impact, determine a timing that minimizes the cost as a start timing of the scheduled maintenance when the selected handling procedure is the scheduled maintenance, and sort the selected handling procedure to any of the automatic handling, the scheduled maintenance, and the emergency measures.

According to one aspect of the present invention, there is provided a monitoring and maintenance method that monitors a service for which service quality provisions have been established and sorts fault handling into automatic handling done automatically, scheduled maintenance carried out by an operator in a predetermined time slot, and emergency measures taken promptly by an expert, the method being performed by a computer, the method comprising the steps of: extracting fault handling procedures and acquiring a degree of impact of carrying out the handling procedures; assessing cost according to a timing of carrying out the handling procedures and determining a timing that minimizes the cost; and selecting a handling procedure to be carried out, based on cost required for handling and on the degree of impact, determining a timing that minimizes the cost as a start timing of the scheduled maintenance when the selected handling procedure is the scheduled maintenance, and sorting the selected handling procedure to any of the automatic handling, the scheduled maintenance, and the emergency measures.

### Effects of the Invention

The present invention makes it possible to automatically and quickly determine an efficient timing to do handling.

### BRIEF DESCRIPTION OF DRAWINGS

FIG. 1 is an overall configuration diagram including a monitoring and maintenance apparatus according to the present embodiment.

FIG. 2 is a functional block diagram showing a configuration of an extraction unit.

FIG. 3 is a flowchart showing a process flow of the monitoring and maintenance apparatus according to the present embodiment.

FIG. 4 is a diagram showing total cost when a failure occurs before a holiday.

FIG. 5 is a diagram showing total cost when a failure occurs during a holiday.

FIG. 6 is a diagram explaining a sum total of human resource cost.

FIG. 7 is a diagram showing changes in refund amount from service to service.

FIG. 8 is a diagram showing changes in churn rate from service to service.

FIG. 9 is a diagram showing a hardware configuration of the monitoring and maintenance apparatus.

### DESCRIPTION OF EMBODIMENTS

An embodiment of the present invention will be described below with reference to the drawings.

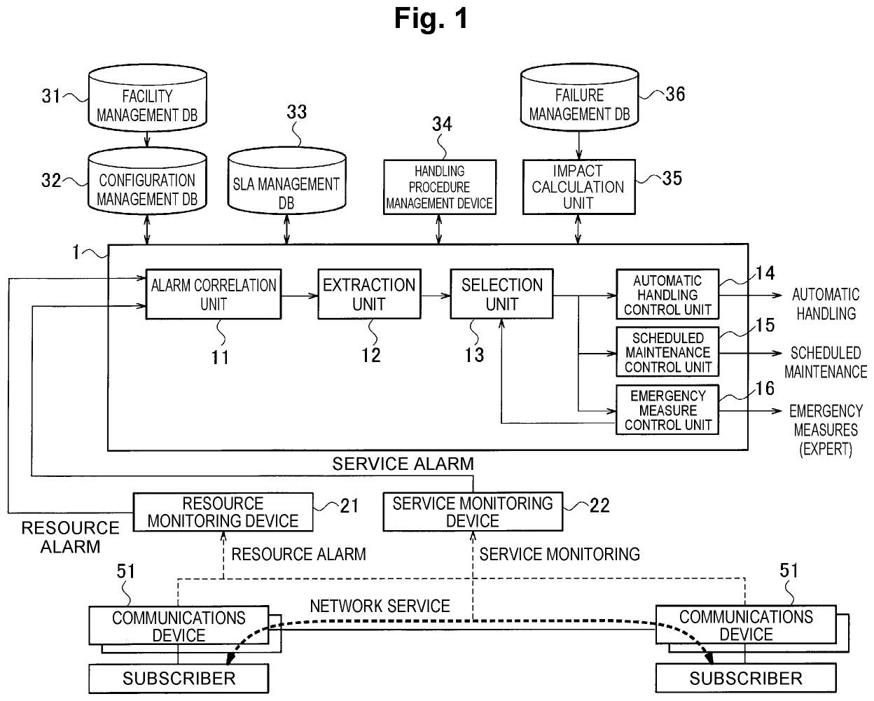

FIG. 1 is an overall configuration diagram including a monitoring and maintenance apparatus according to the present embodiment. The monitoring and maintenance apparatus 1 monitors and maintains network services provided to subscribers on a network constructed with communications devices 51 such as routers and switches. The monitoring and maintenance apparatus 1 may monitor a virtualized network constructed using NFV (Network Function Virtualization) and network services provided on the virtualized network.

A resource monitoring device 21 monitors states of resources such as the communications devices 51. If any abnormality of the communications devices 51 is detected, the resource monitoring device 21 transmits a resource alarm to the monitoring and maintenance apparatus 1. The resource monitoring device 21 may detect abnormalities of communications devices 51, for example, using SNMP (Simple Network Management Protocol) or streaming telemetry.

A service monitoring device 22 monitors service quality maintenance status for each unit (e.g., user unit, device unit, or line unit) that provides for quality of service, and detects any violation of service quality provisions. If any violation of service quality provisions is detected, the service monitoring device 22 transmits a service alarm to the monitoring and maintenance apparatus 1. The service monitoring device 22 monitors quality of network services, for example, by measuring traffic and applying test traffic.

Upon receiving a resource alarm and a service alarm, the monitoring and maintenance apparatus 1 identifies an incident (event that causes service interruption or quality degradation), based on the received alarms. The monitoring and maintenance apparatus 1 extracts a group of handling procedures for the incident, determines a timing that minimizes cost, and selects an optimum handling procedure to deal with the incident. The handling procedures are roughly classified into automatic handling, scheduled maintenance, and emergency measures. The automatic handling, which requires no operator, restarts a device or a service automatically. The scheduled maintenance is carried out by operators during a usual operation within a set period such as in the daytime on a weekday. The emergency measures are taken promptly by a skilled operator (expert) any time day or night. Generally, cost (maintenance cost) increases in the order: automatic handling, scheduled maintenance, and emergency measures. Also, the scheduled maintenance and emergency measures that require operators involve higher maintenance cost in the nighttime on holidays than maintenance cost in the daytime on weekdays.

The monitoring and maintenance apparatus 1 includes an alarm correlation unit 11, an extraction unit 12, a selection unit 13, an automatic handling control unit 14, a scheduled maintenance control unit 15, and an emergency measure control unit 16.

The alarm correlation unit 11 receives the resource alarm and the service alarm, aggregates the received alarms, and treat the alarms as an incident. The alarm correlation unit 11 identifies a cause alarm and a secondary alarm and derives a resource, service, and a service quality provision risk related to the incident that has occurred. When a device fails, not only the failed device, but also other related devices may output an alarm. If any service is affected by a device failure, the service monitoring device 22 outputs a service alarm. The alarm correlation unit aggregates these alarms and identifies the cause alarm and the secondary alarm.

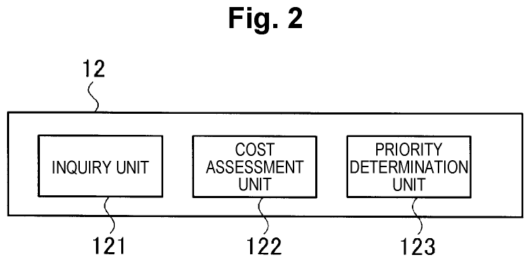

The extraction unit 12 extracts handling procedures for the incident, assesses cost of the handling procedures, thereby determines a timing that minimizes the cost, and determines priorities of the handling procedures. As shown in FIG. 2, the extraction unit 12 includes an inquiry unit 121, a cost assessment unit 122, and a priority determination unit 123.

The inquiry unit 121 inquires of a handling procedure management device 34 about a handling procedure for the incident. When there are plural handling procedures, the handling procedure management device 34 returns the plural handling procedures. The handling procedure includes, for example, handling procedure details and is provided with information as to whether or not local support (operator) is necessary and information as to whether or not automatic execution is necessary.

Also, the inquiry unit 121 inquires of an impact calculation unit 35 about a degree of impact of carrying out each handling procedure. The degree of impact of carrying out a handling procedure means the likelihood of service/resource recovery, impacts of the handling, and recovery time when the handling procedure is carried out. The likelihood of service/resource recovery is a service/resource recovery rate found from results of the handling procedures carried out in the past. The impacts of handling mean impacts of service interruption, quality deterioration, and the like occurring when the handling procedure is carried out. For example, when the handling done involves restarting a device, the service provided by the device is interrupted for a certain period of time. Therefore, if the device is restarted to deal with the service affected by the fault, other unaffected services provided by the same device may get affected. The recovery time is the time taken to recover from the service interruption and quality deterioration. For example, after the device is restarted, if a large number of services simultaneously request authentication for service recovery, waiting time for authentication is included in the recovery time.

The cost assessment unit 122 assesses the cost according to the timing to start handling based on human cost and SLA violation cost. The cost assessment unit 122 designates the timing that minimizes the cost as a start timing of a handling procedure. Details of cost assessments made by the cost assessment unit 122 will be described later.

The priority determination unit 123 assigns priority to each handling procedure from the viewpoint of service quality provisions and maintenance cost. For example, of the handling procedures, the priority determination unit 123 gives high priority to a procedure that does not require local support, a procedure that allows automatic execution, a procedure that is highly likely to effect service recovery, a procedure that has a reduced impact, and a procedure that takes a reduced recovery time. The priority determination unit 123 may give high priority to a handling procedure that involves low cost as assessed by the cost assessment unit 122.

The selection unit 13 selects the handling procedure with the highest priority and sorts the handling procedure to any automatic handling, scheduled maintenance, and emergency measures. For example, the selection unit 13 sorts a handling procedure that lends itself to automatic execution without requiring local support to automatic execution. The selection unit 13 sorts a handling procedure that needs immediate attention and a handling procedure that needs expert attention to emergency measures. The selection unit 13 sorts a handling procedure that can be incorporated into a maintenance plan to scheduled maintenance.

The automatic handling control unit 14 performs a series of processes according to the handling procedure sorted to automatic execution. For example, the automatic handling control unit 14 performs a process of stopping a service, a process of restarting the communications devices 51, a process of resuming the service, and other processes. In providing network services in a virtualized network, when performance-related service quality provisions are violated or might be violated, the automatic handling control unit 14 may dynamically configure and control the virtualized network. By dynamically configuring and controlling the virtualized network, the service quality provisions can be complied with.

To carry out the handling procedure sorted to scheduled maintenance, the scheduled maintenance control unit 15 selects a time slot in which an operation burden is minimized and a working method (planning, addition to an existing plan), and creates a maintenance plan. For example, the scheduled maintenance control unit 15, which holds information about an operator ID, manageable operations, manageable areas, and available working hours of each operator, assigns an operator suited to carry out the handling procedure.

The emergency measure control unit 16 requests an expert to take emergency measures for a handling procedure sorted to emergency measures. For example, the emergency measure control unit 16 transmits a message to a portable terminal carried by the operator, requesting the operator to take emergency measures. If the operator does not have vacant time and is not available for emergency response, the emergency measure control unit 16 may notify the selection unit 13 that a handling procedure will be selected anew.

A facility management database (DB) 31 holds information about facilities, accommodated users, a contracted service, the presence or absence of an important line, and the like.

A configuration information management DB 32 manages configuration information that allows a resource layer and a service layer to be managed integrally. By referring to the configuration information management DB 32, the alarm correlation unit 11 derives a resource and a service related to an incident.

An SLA management DB 33 holds items of service quality provisions and a range (e.g., a range of continuous values or integer values) of quality provisions for each unit that provides for service quality. Conceivable examples of service quality provisions include provisions concerning reliability such as availability, MTTF (Mean Time To Failure), MTTR (Mean Time To Repair), and user impact as well as provisions concerning performance such as throughput, delay, jitter, and packet loss. Specific examples related to service quality provisions include a provision stipulating in terms of availability of service that proper operation be guaranteed for 99.5% of the one month's operating time (e.g., 720 hours). Service quality provisions according to the present embodiment include provisions used by a service operator as its own quality standards based on the idea of a service level agreement (SLA) agreeing to a quality indicator and a target value by being contingent on a service agreement. Specifically, even if there is no SLA made with a customer, any quality standards determined by the service operator itself is used as an SLA. Because the service quality provisions determined by the service operator itself are not an agreement with the customer, even if they are violated, no penalty is charged, but the credibility with the customer will be damaged. If the loss of the credibility with the customer increases, usage fee revenue is expected to decrease due to service contract cancellation and the like.

In response to an inquiry from the inquiry unit 121, the handling procedure management device 34 extracts details of a handling procedure group and individual handling procedures based on information about a cause alarm, where the handling procedure group includes at least one handling procedure. For example, the handling procedure management device 34 holds a correspondence table associating alarms, resources or services, and handling procedures with one another, and extracts appropriate handling procedures upon receiving information about a resource or a service associated with a cause alarm.

In response to an inquiry from the inquiry unit 121, the impact calculation unit 35 calculates the likelihood of service/resource recovery, impacts of the handling on related services, and recovery time, in relation to the handling procedure, based on information about the service associated with the resource to be handled. Based on the calculated impacts of the handling and recovery time, the impact calculation unit 35 may inquire of the SLA management DB 33 about a violation level of service quality provisions when the handling procedure is carried out.

A failure management DB 36 holds a past history of handling as well as impacts on the entire network at the time of handling and at the time of communications restoration resulting from recovery. The failure management DB 36 manages the history by associating handled resources, a recovery record indicating recovery rates at which recovery from faults has been brought about by the handling procedures, impacts of handling and handling times, and recovery times taken until recovery, for example, with handling procedures carried out in the past. The impact calculation unit 35 calculates impacts of handling on related services and recovery time with reference to the failure management DB 36.

Next, operation of the monitoring and maintenance apparatus 1 according to the present embodiment will be described.

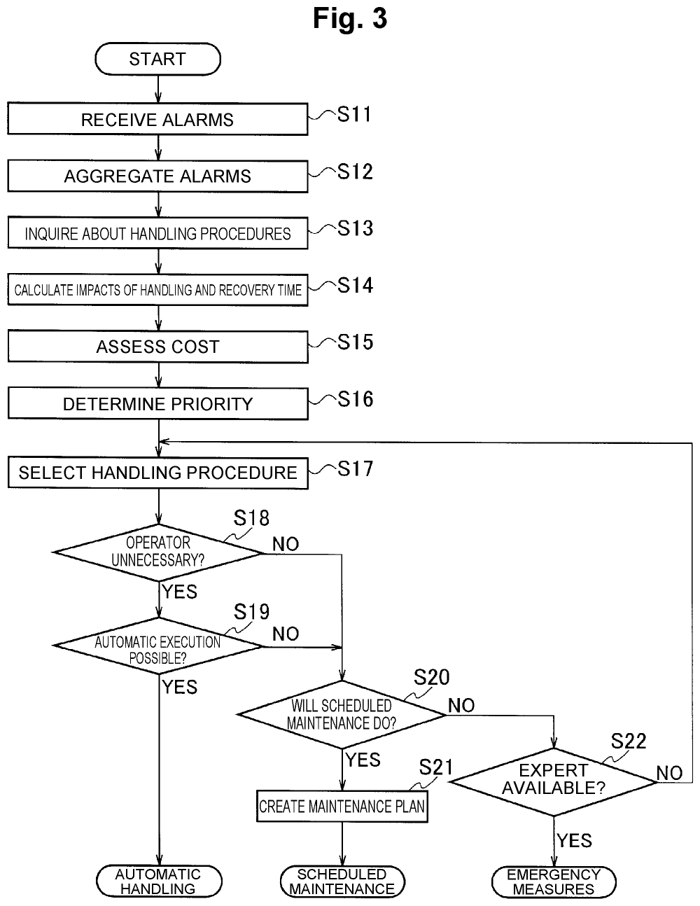

FIG. 3 is a flowchart showing a process flow of the monitoring and maintenance apparatus 1 according to the present embodiment.

In step S11, the alarm correlation unit 11 receives a resource alarm and a service alarm (step S11). If the resource monitoring device 21 detects a failure of the resource or the service monitoring device 22 detects any violation of service quality provisions, a resource alarm and a service alarm are sent out.

In step S12, the alarm correlation unit 11 aggregates the received alarms and identifies the incident that has occurred.

In step S13, the inquiry unit 121 inquires of the handling procedure management device 34 about handling procedures for the incident.

In step S14, the inquiry unit 121 inquires of the impact calculation unit 35 about impacts of handling and recovery time regarding each of the handling procedures obtained in step S13.

In step S15, regarding each of the handling procedures, the cost assessment unit 122 assesses cost according to start timing and designates the timing that minimizes the cost as a start timing of the handling procedure.

In step S16, the priority determination unit 123 determines priority of each handling procedure.

In step S17, the selection unit 13 selects a handling procedure with high priority.

In steps S18 and S19, the selection unit 13 determines whether the selected handling procedure needs local support or allows automatic execution. The selection unit 13 assigns the handling procedure that does not need local support and allows automatic execution to the automatic handling control unit 14. The automatic handling control unit 14 carries out handling according to the handling procedure.

In step S20, the selection unit 13 determines whether the selected handling procedure can be dealt with by scheduled maintenance. For example, if the start timing found by the cost assessment unit 122 falls within a time slot of scheduled maintenance, the selection unit 13 determines that the handling procedure can be dealt with by scheduled maintenance. If the handling procedure can be dealt with by scheduled maintenance, the selection unit 13 assigns the handling procedure that can be dealt with by scheduled maintenance to the scheduled maintenance control unit 15.

In step S21, the scheduled maintenance control unit 15 works out a maintenance plan according to the handling procedure. Subsequently, the handling procedure is carried out within the scheduled maintenance.

If the handling procedure cannot be dealt with by scheduled maintenance, the selection unit 13 assigns the handling procedure to the emergency measure control unit 16.

In step S22, the emergency measure control unit 16 requests an expert to take emergency measures and waits for the request to be accepted by the expert.

If there is any expert who can take measures, emergency measures are taken by the expert.

If there is no expert who can take measures, the processing returns to step S17. The selection unit 13 selects, for example, a handling procedure with the next higher priority.

Next, cost assessments made by the cost assessment unit 122 for the handling procedure will be described.

According to the present embodiment, the cost assessment unit 122 determines the most suitable start timing of handling from the viewpoint of cost. Specifically, for each timing to start handling, the cost assessment unit 122 assesses the cost of the handling by converting human resources needed for the handling, refund in case of SLA violation, and lost profits into cost. The cost assessment unit 122 designates the timing that minimizes the cost as a start timing of the handling procedure. Note that because automatic handling is performed automatically without the need for manual work and emergency measures are taken promptly, the start timing determined by the cost assessment unit 122 is the timing to carry out scheduled maintenance. By designating, for example, a period of four days from the occurrence of a fault as an assessment period, the cost assessment unit 122 finds the start timing that minimizes the cost within the assessment period. The assessment period may be extended by taking consecutive holidays and the like into consideration or may be set by factoring in an SLA refund amount or lost profits.

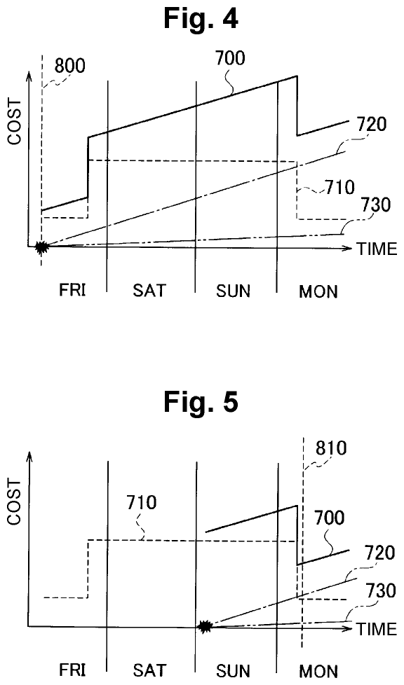

A relationship between an elapsed time from failure detection and cost at the time of failure recovery is shown in FIGS. 4 and 5. FIGS. 4 and 5, in which the abscissa represents time while the ordinate represents cost, show changes in human resource cost 710, SLA violation-related refund 720, lost profits 730, and total cost 700 with time. The human resource cost 710 is generally low in the daytime on weekdays, and high in the nighttime and on holidays. The SLA violation-related refund 720 is determined by the agreement, and increases depending on the period in which services that satisfy the SLA are not provided. The lost profits 730 are losses caused by service cancellation and the like due to credibility loss. The longer the failure period, the more greatly credibility is lost, and usage fee revenue is expected to decrease.

Suppose a fault occurs on Friday before a holiday, for example, as shown in FIG. 4. In this case, because postponement of handling only results in increases in the total cost 700, it is best in terms of cost to carry out handling at time 800 immediately after failure detection.

Alternatively, suppose a fault occurs during a holiday as shown in FIG. 5. In this case, because prompt handling will involve the human resource cost 710, it is best in terms of cost to carry out handling at time 810 on the next business day by postponing the handling.

The cost assessment unit 122 calculates cost, for example, using the next expression.

$$Assessment {cost}_{( {t}_{start} )} = l \cdot {\int }_{{t}_{start}}^{{t}_{complete}} {HC}_{( t )} dt + {\sum }_{i = 1}^{j} {m}_{( i )} \cdot FU \cdot {VC}_{( {t}_{complete} , i )} + {\sum }_{i = 1}^{j} {n}_{( i )} \cdot FU \cdot UF \cdot {CR}_{( {t}_{complete} , i )} \qquad [ Math . 1 ]$$

where tₛₜₐᵣₜ is the start time of failure handling measures, t_{complete} is estimated time of failure recovery, l, m, and n are weighting variables (m and n can be changed according to the service), HC(t) is handling cost at time t, VC(t,i) is a refund amount for a service i at time t, FU (Failure User number) is the number of users affected by the failure, UF is a usage fee (usage fee that can be expected in the future), and CR(t,i) is a churn rate for the service i at time t.

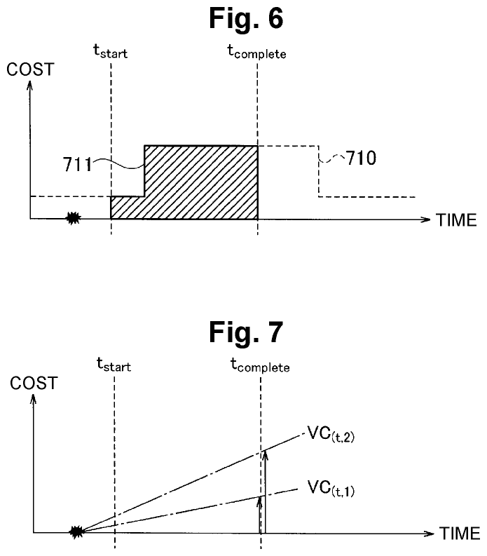

The first term of the expression for cost calculation is a sum total of human resource cost incurred from the start time of failure handling measures tₛₜₐᵣₜ to the estimated time of failure recovery t_{complete}. A region 711 from the start time of failure handling measures tₛₜₐᵣₜ to the estimated time of failure recovery t_{complete} in FIG. 6 is the sum total of human resource cost.

The second term of the expression for cost calculation is a sum total of return amounts of plural services i at the estimated time of failure recovery t_{complete}. The example of FIG. 7 shows changes in the refund amounts VC_{(t,1)} and VC_{(t,2)} starting from the occurrence of failures in respective services 1 and 2. In calculating cost, the sum total of refund amounts is found based on refund amounts VC_{(tcomplete,1)} and VC_{(tcomplete,2)} from the services 1 and 2 at the estimated time of failure recovery t_{complete}.

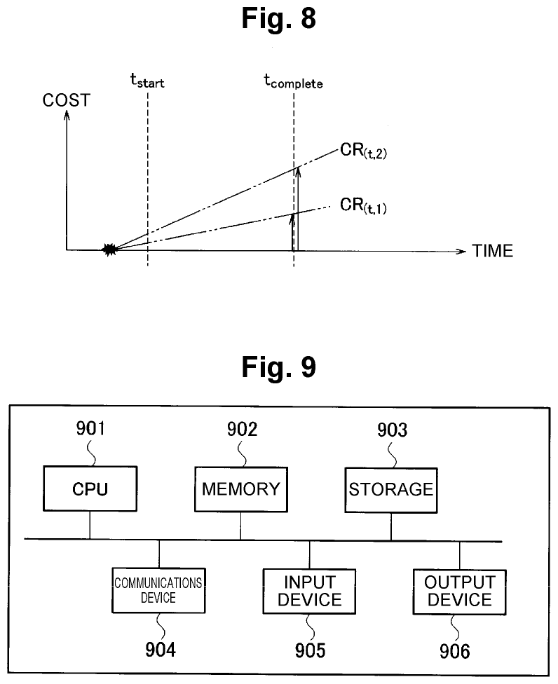

The third term of the expression for cost calculation is a sum total of lost profits from the respective services i expected from losses of credibility with customers. The example of FIG. 8 shows changes in churn rates CR_{(t,1)} and CR_{(t,2)} expected based on the elapsed time from the occurrence of failures in the respective services 1 and 2. In calculating cost, the sum total of lost profits is found based on churn rates CR_{(tcomplete,1)} and CR_{(tcomplete,2)} of the respective services 1 and 2 expected to be canceled at the estimated time of failure recovery t_{complete}.

As described above, when a fault occurs, in the monitoring and maintenance apparatus 1 according to the present embodiment, the inquiry unit 121 extracts fault handling procedures and acquires the degree of impact of carrying out the handling procedures. The cost assessment unit 122 assesses cost according to a timing of carrying out the handling procedures and determines the timing that minimizes cost. The selection unit 13 selects a handling procedure to be carried out, based on whether or not operators are necessary and on the degree of impact, designates the timing that minimizes the cost as the timing to carry out the handling procedure, and sorts the handling procedure to any the automatic handling, the scheduled maintenance, and the emergency measures. This allows the monitoring and maintenance apparatus 1 to automatically and quickly determine an efficient timing to carry out the handling procedure.

Note that the present invention is not limited to the embodiment described above and that various changes can be made without departing from the scope of the present invention.

A general-purpose computer system such as shown in FIG. 9, for example, can be used for the monitoring and maintenance apparatus 1 according to the above embodiment, where the computer system includes a central processing unit (CPU) 901, a memory 902, a storage 903, a communications device 904, an input device 905, and an output device 906. On the computer system, as the CPU 901 executes a predetermined program loaded into the memory 902, the monitoring and maintenance apparatus 1 is implemented. The program can be recorded on a computer-readable recording medium such as a magnetic disk, optical disc, or semiconductor memory or distributed via a network.

Note that the monitoring and maintenance apparatus 1 may be implemented by a single computer or by two or more computers. The monitoring and maintenance apparatus 1 may be implemented by a virtual machine.

### REFERENCE SIGNS LIST

1 Monitoring and maintenance apparatus
11 Alarm correlation unit
12 Extraction unit
121 Inquiry unit
122 Cost assessment unit
123 Priority determination unit
13 Selection unit
14 Automatic handling control unit
15 Scheduled maintenance control unit
16 Emergency measure control unit
21 Resource monitoring device
22 Service monitoring device
32 Configuration information management DB
33 SLA management DB
34 Handling procedure management device
35 Impact calculation unit
36 Failure management DB
51 Communications device

1. A monitoring and maintenance apparatus configured to monitor a service for which service quality provisions have been established and sorts fault handling into automatic handling done automatically, scheduled maintenance carried out by an operator in a predetermined time slot, and emergency measures taken promptly by an expert, the apparatus comprising:
an extraction unit, including one or more processors, adapted to extract fault handling procedures and acquire a degree of impact of carrying out the handling procedures;
a cost assessment unit, including one or more processors, adapted to assess cost according to a timing of carrying out the handling procedures and determine a timing that minimizes the cost; and
a selection unit, including one or more processors, adapted to select a handling procedure to be carried out, based on cost required for handling and on the degree of impact, determine a timing that minimizes the cost as a start timing of the scheduled maintenance when the selected handling procedure is the scheduled maintenance, and sort the selected handling procedure to any of the automatic handling, the scheduled maintenance, and the emergency measures.

2. The monitoring and maintenance apparatus according to claim 1, wherein the cost assessment unit is configured to assess the cost in relation to a plurality of timings based on human resource cost, a refund amount in case of violation of service quality provisions, and lost profits.

3. A monitoring and maintenance method that monitors a service for which service quality provisions have been established and sorts fault handling into automatic handling done automatically, scheduled maintenance carried out by an operator in a predetermined time slot, and emergency measures taken promptly by an expert, the method being performed by a computer, the method comprising the steps of:
extracting fault handling procedures and acquiring a degree of impact of carrying out the handling procedures;
assessing cost according to a timing of carrying out the handling procedures and determining a timing that minimizes the cost; and
selecting a handling procedure to be carried out, based on cost required for handling and on the degree of impact, determining a timing that minimizes the cost as a start timing of the scheduled maintenance when the selected handling procedure is the scheduled maintenance, and sorting the handling procedure to any of the automatic handling, the scheduled maintenance, and the emergency measures.

4. The monitoring and maintenance method according to claim 3, wherein in the assessing cost, the cost is assessed in relation to a plurality of timings based on human resource cost, a refund amount in case of violation of service quality provisions, and lost profits.

5. A non-transitory computer readable medium storing one or more instructions causing a computer to execute:
monitoring a service for which service quality provisions have been established and sorts fault handling into automatic handling done automatically, scheduled maintenance carried out by an operator in a predetermined time slot, and emergency measures taken promptly by an expert, comprising:
extracting fault handling procedures and acquiring a degree of impact of carrying out the handling procedures;
assessing cost according to a timing of carrying out the handling procedures and determining a timing that minimizes the cost; and
selecting a handling procedure to be carried out, based on cost required for handling and on the degree of impact, determining a timing that minimizes the cost as a start timing of the scheduled maintenance when the selected handling procedure is the scheduled maintenance, and sorting the handling procedure to any of the automatic handling, the scheduled maintenance, and the emergency measures.

6. The non-transitory computer readable medium according to claim 5, further comprising:
assessing the cost in relation to a plurality of timings based on human resource cost, a refund amount in case of violation of service quality provisions, and lost profits.
